(19) United States
(12) Patent Application Publication
(10) Pub. No.: US 2008/0129654 A1
(43) Pub. Date: Jun. 5, 2008

(54) MULI-SIGNAL DISPLAYER

(76) Inventor: Dilip Bhavnani, Beverly Hills, CA (US)

Correspondence Address: THE SONI LAW FIRM, 55 S. LAKE AVE SUITE 720, PASADENA, CA, 91101, US

(21) Appl. No.: 11/566,159

(22) Filed: Dec. 1, 2006

(51) Int. Cl. G09G 3/20; G04B 23/02

(52) U.S. Cl. 345/59; 368/72

(57) ABSTRACT

A multi-signal desktop digital displayer that can selectively display digital signals created from digital utilities such as a clock, timer, alarm, or thermometer by rotating a large artistically designed disc. The multi-signal displayer has a housing to encase electric circuitry, a disc rotatably mounted on the front face of the housing and a display screen. The disc is configured to selectively activate different digital utilities one by one as it rotates by a preset degrees of an angle to display the digital signal generated therefrom one by one. In the preferred embodiment, the displayer is also configured to reverse the shades of display, for each digital signal, as the disk rotates, that is, from bright background to dark background and from dark image to bright image.

### FIELD OF THE INVENTION

The present invention relates to field of a desktop displayer that selectively displays multiple digital signals, such as time, alarm setting, countdown timer, or temperature by rotating a disc mounted thereon.

### CROSS-REFERENCE TO RELATED APPLICATION

(Not Applicable)

### STATEMENT RE: FEDERALLY SPONSORED RESEARCH/DEVELOPMENT

(Not Applicable)

### BACKGROUND OF THE INVENTION

Desktop digital assemblies that conveniently incorporate common digital accessories such as a clock, timer, alarm, or thermometer, are widely used in business offices, houses, or other living spaces. Some of such digital desktop assemblies commercially available in the market are designed to display all different kinds of digital signals together on a single or multiple digital screens. Others are designed to display selectively only a single kind of digital signal at a time, which is selected via some signal selection means attached thereon.

When buyers make a purchase decision among various such digital assemblies available in the market, they often consider not only the functionality, convenience or efficiency in operating those incorporated digital functions, but also how the operating means are designed creatively so as to enhance the aesthetics of the product as well, being combined or harmonized with and the aesthetic features thereof, since in modern days, such digital desktop assemblies also serves as an important part of room decoration. Therefore, it would be advantageous if a multi-signal desktop digital displayers is designed not only to carry various widely used desktop digital functions, but also to have its functional features combined with aesthetical features to attract the attention of buyers or viewers. Although several kinds of multi-signal desktop displayers that can selectively display one kind of signals at a time in the prior art, none of them, however, discloses using an aesthetically designed disc as a signal selection means. Therefore, it is desirable to provide a multi-signal desktop displayer that combines several common digital functions such as a clock, timer, alarm, or thermometer which can be selectively displayed one by one by rotating a disc that, by itself, forms a major aesthetic feature of the displayer. Further, it would be desirable if such desktop multi-function frame can provide even some space to place advertising materials for advertisement.

### SUMMARY OF THE INVENTION

The present invention provides a multi-signal desktop digital displayer that can selectively display common digital utilities such as a clock, timer, alarm, or thermometer, one by one, by rotating a large artistically designed disc mounted on the front face of the displayer.

The multi-signal displayer made in accordance with the present invention is largely comprised, in the preferred embodiment, of a housing, disposed therein, a plurality of digital signal generators, such as a clock, timer, alarm, or thermometer, a disc rotatably mounted on the housing and configured to selectively activate the digital signal generators upon rotation thereof, and a display screen disposed on the housing. The display screen is configured to display a different digital signal at a time when the digital signal generator generating that signal is activated by rotating the disc by a predetermined amount of degree. In another preferred embodiment, the displayer is also configured to reverse the shades of display, for each digital signal, as the disk rotates, that is, from bright background to dark background and from dark image to bright image.

The multi-signal displayer may further have a plurality of input units on an outer surface of the housing for time and alarm setting, and advertising material disposed on a visible outer surface thereof.

### BRIEF DESCRIPTION OF THE DRAWINGS

FIG. 1 is a perspective view of the multi-signal displayer made in the preferred embodiment of the present invention;

FIG. 2 is a front elevational view of the multi-signal displayer made in the preferred embodiment of the present invention;

FIG. 3 is a top plan view, in the perspective, of the multi-signal displayer made in the preferred embodiment of the present invention;

FIG. 4 is a side elevational view of the multi-signal displayer made in the preferred embodiment of the present invention;

FIG. 5 is a bottom plan view, in the perspective, of the multi-signal displayer made in the preferred embodiment of the present invention; and

FIG. 6 is a rear elevational view of the multi-signal displayer made in the preferred embodiment of the present invention.

### DETAILED DESCRIPTION OF THE INVENTION

The present invention generally relates to a multi-signal desktop digital displayer that can selectively display common digital utilities such as a clock, timer, alarm, or thermometer, one by one, by rotating a large artistically designed disc mounted on the front face of the displayer.

Several preferred embodiments of the present invention will now be described with reference to figures (‘FIGS.’) 1-6, wherein like components are designated by like reference numerals throughout the figures. With regards to means for fastening, mounting, attaching or connecting the components of the present invention to form the assembly as a whole, unless specifically described otherwise, such means are intended to at least encompass conventional fasteners such as machine screws, machine threads, snap rings, hose clamps, rivets, nuts and bolts, toggles, pins and the like. Components may also be connected by frictional fitting, snap fitting, adhesives or by welding or deformation, if appropriate. Unless specifically otherwise disclosed or taught, materials for making components of the present invention are selected from appropriate materials such as metal, ceramics, metallic alloys, natural or synthetic fibers, plastics and the like, and appropriate manufacturing or production methods including casting, extruding, injection molding and machines may be used.

Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

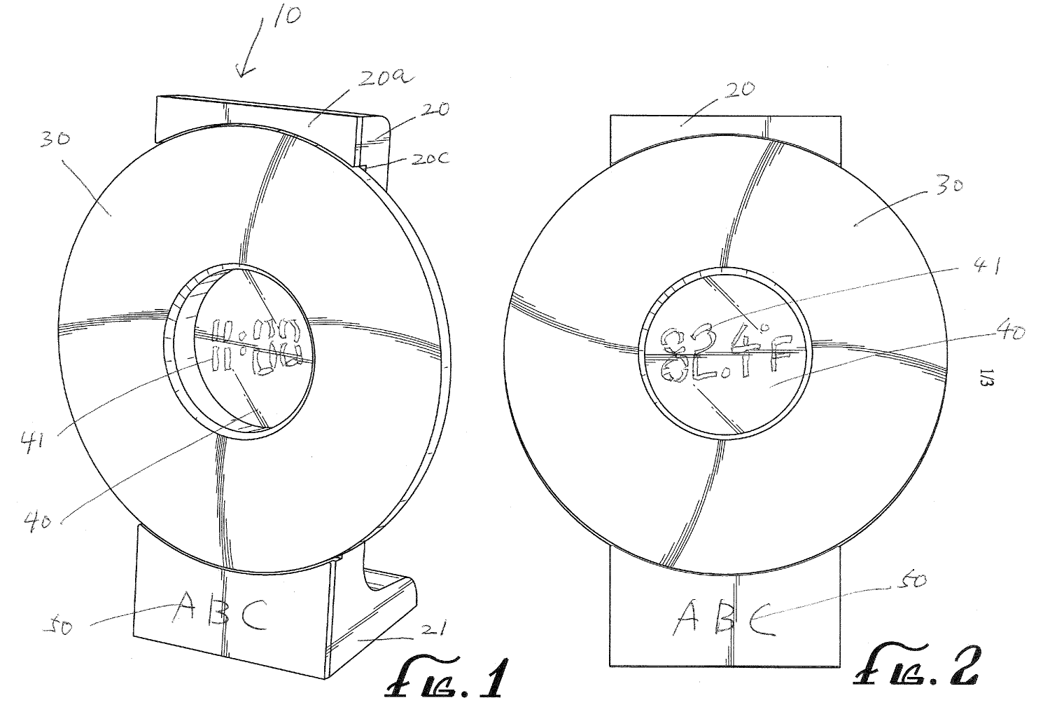

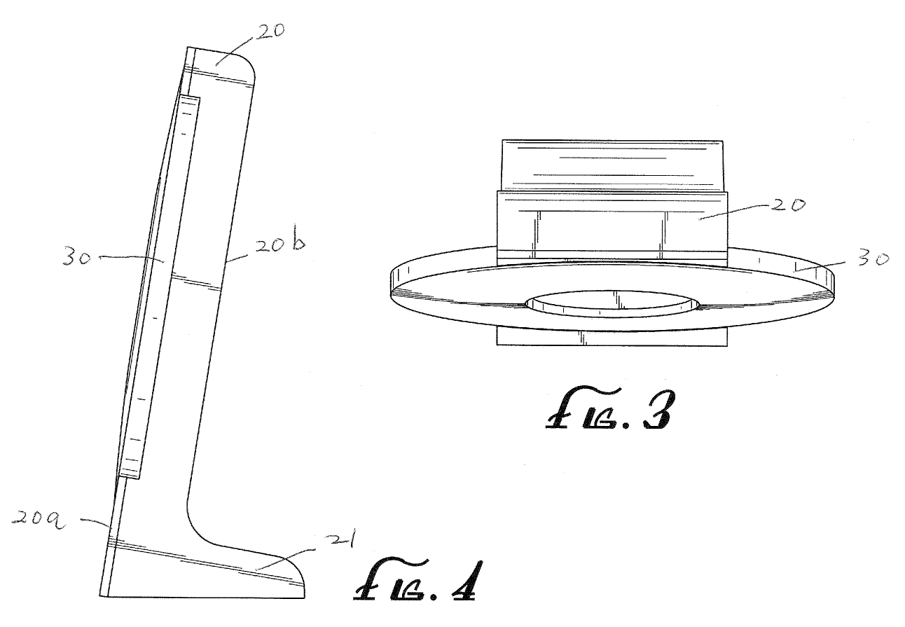

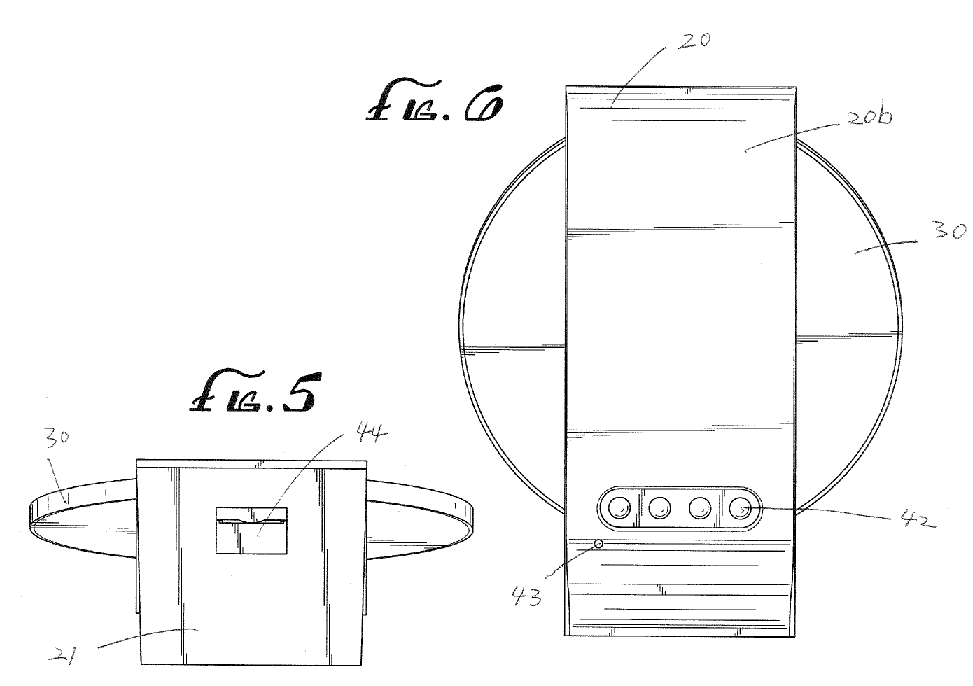

Now referring to FIG. 1, the multi-signal desktop digital displayer 10 made in the preferred embodiment of the present invention comprises largely a housing 20, a disc 30 mounted thereon, a plurality of digital signal generators encased with the housing 20, and a display screen 40 for displaying the digital information 41 generated by the signal generators. The housing 20 has a substantially flat front surface 20a and an opposing rear surface 20b to define an enclosure therebetween to retain the electric circuitry for the digital signal generators and the display screen 40 therein. The housing 10 may have a flat bottom 21 substantially perpendicular to the front surface 20a of the housing 20 so that the displayer 10 may stand thereon. The flat bottom 21 may be integrally formed with the rest of the housing 20 as in the preferred embodiment, or in another embodiment, it may be a separate stand to mount the housing 20 thereon.

The digital signal generators (not shown) in the preferred embodiment are a digital clock, a countdown alarm, a timer, and a thermometer, each generating a different kind of digital signal 41 that is, respectively, time, alarm setting, timer setting, and current temperature. The electric circuitry for each digital signal generator is well known in the art and thus, not described herein further. For setting time or alarming time, or activating and deactivating timer, a plurality of control buttons may be formed on the rear surface 20b of the housing, and further, for emitting alarm sound, a tiny speaker, or sound outlet 43 may be formed on the housing as shown in FIG. 6. Preferably, the power to operate the electric circuitry of signal generators and the display screen 40 is supplied from conventional AA or cell batteries preferably formed in a battery compartment 44 formed at the bottom of the housing 20.

The display screen 40 is formed on the front surface 20a of the housing 20 and, in the preferred embodiment, a liquid crystal display (LCD) is used for that. In another embodiment, however, any other displaying technology well known to those skilled in the art, such as a light emitting diode (LED), may be used.

In the preferred embodiment, the display screen 40 displays only a single kind of digital signal. As a means for selective displaying different kinds of digital signals 41, a thin and flat disk 30 is rotatably mounted on the front surface 20a of the housing 20. For that, the housing 20 defines a recess 20c thereon having a depth substantially equal to the thickness of the disk 30 and a size to parallelly fit the disk 30 therein. The rotational connection between the housing 20 and the disk 30 may be achieved by various rotational fastening means well known in the art. Preferably, the disk 30 has a substantially circular shape but could have any other symmetric polygonal shape such as a triangle, a square, a pentagon and etc. The disk 30 defines a circular display window preferably at the center, which is sized to expose the display screen 40 therethrough.

The disk 30 is electrically connected to the electric circuitry of the signal generators such that as the disk 30 rotates, different kind of signal generators are consecutively activated and deactivated one by one at a predetermined interval of rotation angle, and thereby consecutively displaying different kind of digital signals 41 on the display screen 40. In the preferred embodiment, at every rotational turn of the disk 30 by approximately 90 degrees, the digital signal 41 displayed on the display screen 40, which is one of the time, alarm setting, timer, and temperature, changes from one kind to the next, following a preset order. The disk 30 may be rotated in either clockwise or counterclockwise direction. The electric circuitry and other mechanical, or electrical elements for achieving such alternating switching on and off of each signal generator pursuant to the rotation of the disk 30 are typical and well-known in the art, and thus, not described herein further. A preferable method of activate each signal generator is by disposing a plurality of tabs in spaced-apart relation along an outer or inner periphery of the disk 30 and disposing a switch on the housing 20 so that rotation of the disk 30 causes the tabs to successively engage the switch. In such an embodiment, one switch is disposed on the housing 20 and each successive engagement of the switch triggers a mode change. However, it is appreciated that other structure may be utilized to provide for successive and alternating switching of each signal generator.

The housing 20 and the disk 30 may be fabricated of any proper material, including but not limited to, wood, metal, plastics, cardboard, polymeric compositions, fiberglass, hardboard, or any other rigid or semi rigid material.

Further in the preferred embodiment, the display screen 40 and the disk 30 are configured to display each of the four different kinds of digital signals 41 in two different modes of display. In one mode, the numerals are dark and the background is clear as is the case with common LCD displays. In the other mode, the colors reverse so that the numerals become clear and the background becomes dark. More specifically, as the disk 30 rotates approximately 90 degrees, the display screen 41 dims, then completely darkens, and then brightens again. This is preferably achieved by employing a polarizer (not shown) fitted in the circular display window of the disk 30 to be positioned in front of the LCD screen 40. As the polarizer rotates together the disk 30 does, the initially dark digital signal 41 on the LCD screen 40 disappears first and then illuminates bright on a dark background, which, at a further rotation of the disk 30, changes to a different kind of digital signal with dark image and bright background and so on. Typically an LCD display is composed of at least 6 layers: a vertical filter film layer, a glass substrate with electrode film, twisted nematic liquid crystals, glass substrate with electrode film, horizontal filter film layer, and a reflective surface. By relocating one of the filter film layers to the rotating disk 30, the effect of an inversely alternating display is produced according to the present invention. More specifically, either the vertical filter or the horizontal filter may be fitted within the disk 30. In this respect, the filter located on the disk 30 completes the LCD display and it is the rotation one of the horizontal and vertical filter film layers with respect to each that allows for the change in color. Then, in this embodiment, the display screen 41 can consecutively display eight different modes of display, which flip from one to the next at rotation of the disk 30 by 90 degrees.

The present invention provides an effective means for advertising and promotion. Since the multi-signal desktop displayer would be more likely to attract attentions of the user and other viewers owing to the interesting way of selecting different integrated digital functions as well as the fanciful outlook from the rotating disk 30, it can be an effective vehicle for advertisement as well. FIGS. 1 and 2 show that advertising materials 50 imprinted on the front surface 20a of the housing 20, preferably below the disk 30. But the advertising material may be imprinted on any outer surface of the housing 20.

The present invention is capable of embodiments other than those described above, and its several details are capable of modifications in various respects apparent to those of ordinary skill in the art, all without departing from the essential spirit or attributes of the invention. Therefore, the embodiments described hereinbefore should be considered to be merely illustrative, not restrictive.

1. A multi-signal displayer, comprising:
a housing;
a plurality of digital signal generators disposed within the housing, each of the digital signal generators being configured to output a unique respective digital signal;
a disc rotatably mounted on the housing and configured to selectively activate the digital signal generators upon rotation thereof; and
a display disposed on the housing and configured to display a different respective one of the digital signals upon activation of a respective one of the digital signal generators via each rotational turn of the disc.

2. The multi-signal displayer as in claim 1, wherein the plurality of digital signal generators comprises at least three unique digital signal generators selected from the group consisting of: a digital clock, a countdown timer, an alarm, and a thermometer.

3. The multi-signal displayer as in claim 2, the plurality of digital signal generators comprises four unique digital signal generators.

4. The multi-signal displayer as in claim 3, wherein each of the digital signal generators are activated by a 90 degree rotational turn of the disc.

5. The multi-signal displayer as in claim 3 further comprising a plurality of input units disposed on an outer surface of the housing.

6. The multi-signal displayer as in claim 1, wherein the disc is configured to rotate in both clockwise and counter-clockwise directions.

7. The multi-signal displayer as in claim 1, wherein the display is a liquid crystal display.

8. The multi-signal displayer as in claim 1, wherein the display is a light emitting diode.

9. The multi-signal displayer as in claim 1, wherein the disc has a substantially circular shape.

10. The multi-signal displayer as in claim 1, wherein the housing has a flat bottom which is perpendicular to a front surface of the housing.

11. The multi-signal displayer as in claim 1 further comprising advertising material disposed on a visible outer surface thereof.

12. A multi-signal displayer, comprising:
a housing;
a plurality of digital signal generators disposed within the housing, each of the digital signal generators being configured to output a unique respective digital signal;
a disc rotatably mounted on the housing and configured to selectively activate the digital signal generators upon rotation thereof;
a display disposed on the housing and configured to display a different respective one of the digital signals upon activation of a respective one of the digital signal generators via each rotational turn of the disc; and
a polarized lens superimposed upon the display, the lens being configured to change color of the display when the disc is rotated.

13. The multi-signal displayer as in claim 12, wherein the plurality of digital signal generators comprises at least three unique digital signal generators selected from the group consisting of: a digital clock, a countdown timer, an alarm, and a thermometer.

14. The multi-signal displayer as in claim 13, wherein the plurality of digital signal generators comprises four unique digital signal generators.

15. The multi-signal displayer as in claim 14, wherein each of the digital signal generators are activated by a 90 degree rotational turn of the disc.

16. The multi-signal displayer as in claim 14 further comprising a plurality of input units disposed on an outer surface of the housing.

17. The multi-signal displayer as in claim 12, wherein the disc is configured to rotate in both clockwise and counter-clockwise directions.

18. The multi-signal displayer as in claim 12, wherein the display is a liquid crystal display.

19. The multi-signal displayer as in claim 12, wherein the display is a light emitting diode.

20. The multi-signal displayer as in claim 12, wherein the disc has a substantially circular shape.

21. The multi-signal displayer as in claim 12, wherein the housing has a flat bottom which is perpendicular to a front surface of the housing.

22. The multi-signal displayer as in claim 12 further comprising advertising material disposed on a visible outer surface thereof.

23. A method of advertising comprising the steps of:
(a) providing a multi-signal displayer comprising:
a housing,
a plurality of digital signal generators disposed within the housing, each of the digital signal generators being configured to output a unique respective digital signal,
a disc rotatably mounted on the housing and configured to selectively activate the digital signal generators upon rotation thereof, and
a display disposed on the housing and configured to display a different respective one of the digital signals upon activation of a respective one of the digital signal generators via each rotational turn of the disc; and
(b) disposing advertising material on a visible outer surface of the displayer.
